(19) United States
(12) Patent Application Publication
(10) Pub. No.: US 2024/0154645 A1
(43) Pub. Date: May 9, 2024

(54) APPARATUS FOR PROCESSING AUDIO AND/OR IMAGE INFORMATION

(71) Applicant: Enna Systems GmbH, München (DE)

(72) Inventors: Jakob Bergmeier, München (DE); Tim Haug, München (DE); Moritz Kutschera, München (DE)

(73) Assignee: Enna Systems GmbH, München (DE)

(21) Appl. No.: 18/279,534

(22) PCT Filed: Mar. 4, 2022
(86) PCT No.: PCT/EP2022/055530

§ 371 Date: Aug. 30, 2023

(30) Foreign Application Priority Data
Mar. 4, 2021 (DE) 10 2021 105 302.1

(51) Int. Cl. H04B 5/73; G11B 31/00

(52) U.S. Cl. CPC H04B 5/73; G11B 31/00

(57) ABSTRACT

The present invention relates to an apparatus for processing audio and/or image information, comprising a rectangular recess which is adapted for the placement of ID cards, a sensor which detects the identifier stored on an ID card and transmits it in the form of identifier-specific signals to a processing unit, in particular fewer than four and preferably two controls (16a,b) which are adapted for controlling digital content, and an output section which reproduces digital content or transmits it to an external reproduction device, the output section comprising a loudspeaker, a docking apparatus, and a mounting support which reduces the pressure on the docking apparatus when a multimedia device is docked onto it.

The present invention relates to an apparatus for processing audio and/or image information and to a system comprising such an apparatus and at least two ID cards.

Multimedia devices such as smartphones, tablets or computers, which, thanks to modern communication technologies, are able to connect their respective users directly to each other by means of various communication channels, are generally known. These multimedia devices also allow access to digital correspondence and digital libraries. In today's digitalized world, such multimedia devices represent an important component whose influence extends far beyond private use. Multimedia devices are therefore very popular with large sections of the population.

Accessing digital content requires mainly manual operation, which can often be complex and challenging, especially for older groups of people such as senior citizens. This is due not only to their sometimes declining cognitive and motor skills, but also to the fact that multimedia devices are not very intuitive for seniors to operate using touchscreens or a mouse and keyboard. Furthermore, attached controls or plug-in connections, especially on mobile multimedia devices, tend to be increasingly delicate and so less senior-friendly. These circumstances often lead to the rejection of multimedia devices by seniors and are thus partly responsible for their digital isolation.

This places seniors at a significant disadvantage when it comes to modern ways of communicating with friends or family.

These problems have been known for some considerable time and have therefore been addressed frequently. For example, there are mobile phones with simplified and enlarged controls, which are mainly intended to ensure that older people are reachable and to preserve their mobility. However, such devices usually have small output units and therefore require good eyesight. Furthermore, the functionality of such mobile phones for senior citizens is generally limited so as to avoid making these devices too complex to operate. However, this characteristic also means that desirable entertainment offerings, such as the playing of audio and/or image information from digital media libraries, are unavailable or hard to access.

Against this background, it is the task of the invention to provide a senior-friendly apparatus that is easy to operate and has a high level of functionality without being overly complex, thereby enabling the digital networking of senior citizens and helping to maintain the independence of this group of people.

To solve this task, according to the invention, an apparatus for processing audio and/or image information is provided, comprising
a substantially rectangular recess adapted for the placement of an identification (ID) card, a sensor for detecting an identifier stored on the ID card,
two controls for controlling the processing of the audio and/or image information, and an output section adapted to reproduce the audio and/or image information or transmit the audio and/or image information to an external reproduction device.

The fundamental idea behind this aspect of the invention is based on the interaction of the stored identifier or identification of an ID card, which is preferably designed in the common credit card format according to ISO/IEC standard 7810 so that it comes easily to hand, with a sensor for detecting the stored identifier. The sensor is able to detect, within an area of its environment, a property or a change of a property of this environment. Furthermore, a substantially rectangular recess, whose size is preferably based on the credit card format according to ISO/IEC standard 7810, serves as a receptacle for an ID card, the sensor preferably being adapted to be affixed centrally on the bottom of the rectangular recess, so that it can directly detect the stored identifier of an ID card when an ID card is placed in the rectangular recess.

According to the first aspect, the apparatus according to the invention includes an output section which is adapted to reproduce audio and/or image information processed by the apparatus or to transmit that audio and/or image information to an external reproduction device. The apparatus according to the invention also includes, in particular, fewer than four controls and preferably two controls which are adapted to control the output of the audio and/or image information processed by the apparatus.

In a preferred embodiment of the apparatus according to the invention, the rectangular recess may form a placement area, the size of the recess being adapted to allow the substantially horizontal placement of an ID card. This embodiment has the advantage that both the placement and the retrieval of an ID card are designed to be intuitive and to present the least possible challenge, even for persons with reduced motor skills. It is also conceivable that the recess can have notches and/or indentations at its corners and/or sides, which are configured to facilitate the retrieval of an ID card from the recess. The depth of the recess is in particular a maximum of 5 mm, preferably a maximum of 2 mm and particularly preferably 0.9 to 0.6 mm. However, it is equally conceivable for the recess to be substantially at an angle of less than 45° to the horizontal rather than forming a horizontal placement area. Furthermore, in an alternative embodiment of the apparatus according to the invention, the placement of an ID card can be equivalently replaced by accommodation in a slot or shaft whose sizes are preferably based on the credit card format according to ISO/IEC standard 7810. With respect to alternative forms of placement or accommodation, the sensor is mounted in close proximity to ensure full detection of the identifier stored on an ID card. Furthermore, all implementations for the placement and accommodation of an ID card can preferably be mounted on the front of the apparatus, thus making them easily accessible, but it is also conceivable that these are positioned on the side, top or rear of the apparatus. Consequently, provision may be made for the attachment of supports and/or clips adapted to secure an ID card while it is placed or accommodated on the apparatus.

In an exemplary variant of the apparatus according to the invention, the sensor that is used may comprise a receiver and/or transmitter for a radio frequency identification (RFID) identifier, preferably a near-field communication (NFC) identifier, which can register an identifier and transmit a resulting signal to a processing unit, for example a processor, for processing. RFID, preferably NFC, is particularly suitable for use in connection with the apparatus according to the invention, as this technology allows contactless registration of the identifier and is also cost-efficient. However, it is also conceivable that the sensor can use alternative communication protocols, such as Bluetooth, for signal transmission.

The apparatus according to the invention can be adapted to trigger a specific action when an ID card with a stored RFID identifier, preferably with a stored NFC identifier, is put in place, which action is output in the form of a specific response of the output section or of the external reproduction device. The specific action relates in particular to the detection of the identifier by the sensor, followed by the identifier-specific signal transmission between the sensor and a processing unit not defined in more detail, and the processing of the identifier-specific signal by the processing unit. This processing unit can access a server via the Internet to retrieve identifier-specific data and consequently make it available for output. Internet access can be provided both by means of a wireless radio network, for example a Wireless Local Area Network (WLAN) according to a standard of the IEEE 802.11 family, and by means of a wired network, for example a local area network (LAN), or by means of a wireless Internet connection provided through the use of a subscriber identity module (SIM) card and based, for example, on the Universal Mobile Telecommunication System (UMTS) standard, the Long-Term Evolution (LTE) standard or their predecessors or successors. Consequently, in an alternative embodiment, the apparatus is characterized in that a corresponding WLAN adapter, Ethernet adapter including a plug-in connection and/or a SIM card module is/are provided on the apparatus.

Similarly, it is conceivable that the retrieved identifier-specific data can be provided both via the Internet and via an internal memory installed in the apparatus, such as a hard disk, or an external memory connected to the apparatus, such as a Universal Serial Bus (USB) connector, all of the said provision methods having the advantage of being able to retrieve data as time-efficiently as possible. Subsequently, the processing unit may send the provided identifier-specific data to an output section or external reproduction device for output in the form of audio and/or image information, this operation constituting the said specific response. Due to the presence of a unit for receiving data from the Internet, it is also possible for the processing unit to download the provided identifier-specific data from the Internet and store it in an internal or external memory.

In a preferred embodiment of the apparatus according to the invention, the triggered specific response is output without any further operator action by the user, thus minimizing the operating effort required of the user. Consequently, audio and/or image information is automatically output by the apparatus according to the invention after the user places an ID card with a stored identifier in the rectangular recess.

In an advantageous embodiment of the apparatus according to the invention, the triggered specific response of the output section or of the external reproduction device includes the output or display of digital content, for example digital correspondence or digital media stored in libraries, or the output or display of phone calls or video calls. In particular, the output section comprises a loudspeaker which is adapted to output the provided audio information. Optionally, the audio information may be output via an external reproduction device, with a plug-in connector, such as a tablet connector or alternatively a High-Definition Multimedia Interface (HDMI) connector, being provided to connect the apparatus to an external reproduction device on the apparatus. In another alternative embodiment, the output section comprises a display screen, such as a liquid crystal display (LCD), which is adapted to output the provided image information.

In particular, the apparatus according to the invention may be characterized in that a triggered specific response in the form of an audio or video communication is established without any further user action. The specific response initiated by the apparatus in the form of an audio or video communication, for example, a phone call or a video call, is essentially initiated by the user placing an ID card with a stored identifier in the rectangular recess, whereupon the connection is established automatically by the apparatus, making the entire connection process extremely user-friendly.

In a preferred embodiment, the apparatus according to the invention is adapted to have only one RFID identifier, preferably one NFC identifier, per ID card at any given time, thereby ensuring the unique assignment of an ID card with a stored identifier in relation to a specific action. Consequently, each ID card with a stored identifier also defines a specific response in the form of audio and/or image information output by the apparatus according to the invention. This means that the user can selectively induce a desired specific response by choosing a particular ID card with a stored identifier, the ID card in question being easily distinguishable from other ID cards by, for example, color coding or labeling.

Optionally, the apparatus according to the invention is characterized in that the in particular fewer than four controls and preferably two controls are disposed adjacent to the rectangular recess in for maximum ease of handling. The length of the controls can be based on the width of the rectangular recess, with the length of the controls preferably being 8 to 4 cm and particularly preferably 7 to 5 cm. It is also conceivable that the width of the controls is between 90% and 10% of the length of the controls. Furthermore, the surfaces of the controls can be designed with symbols, for example directional symbols, for greater user-friendliness.

In a preferred embodiment, the apparatus according to the invention is characterized in that the output section has a docking station for a multimedia device, the docking station creating a connection between a docked multimedia device and the sensor, the controls, the output section, and all plug-in connections of the apparatus according to the invention, and supplying power to the multimedia device in the docked state. Furthermore, an application (app) can be installed on the multimedia device which is capable of registering the identifier-specific signal of an ID card with stored identifier placed in the rectangular recess and communicating with a server for further signal processing via the Internet access provided by the apparatus or by means of its own Internet access, which is enabled, for example, by means of a WLAN wireless network or by means of a wireless Internet connection provided through the use of a SIM card and based, for example, on the Universal Mobile UMTS standard or the LTE standard. In particular, the app can retrieve identifier-specific data from a server or, alternatively, access both data stored on an internal memory of the apparatus and data stored on an external memory connected to the apparatus and transmit this data to the output section in the form of a specific response. Optionally, in the case of a docked multimedia device, the output section is adapted to output the processed image information via the screen of the docked multimedia device, while the processed audio information is output via the integral loudspeaker of the apparatus according to the invention. The multimedia device used is preferably a tablet in one of the common formats, which is compatible with the docking module of the docking station.

According to a second aspect of the invention, the above-mentioned task is solved by means of an alternative system comprising the apparatus according to the invention and characterized in that one apparatus and at least two ID cards are used, the first ID card having an RFID identifier, preferably an NFC identifier, which triggers a first specific response, and the second ID card having a second RFID identifier, preferably an NFC identifier, which triggers a second specific response. Thus, it is clear to a user that each individual ID card with a stored identifier has a specific action associated with it.

Advantageously, a system that includes the apparatus according to the invention can trigger the specific response of the output section or the external reproduction device solely through the identifier of an ID card. This is intended to reflect the idea that the sensor is designed to be able to interact only with the provided ID cards with stored identifiers, on the one hand to ensure corresponding use of the apparatus according to the invention and, on the other hand, to rule out interference with other RFID or NFC identifiers that happen to be nearby.

In a further development of the described system, the triggered specific response can be reprogrammed any number of times. It is thus conceivable that new attributes are assigned to a specific action initiated by the placement of an ID card with a stored identifier, whereby an identifier-specific data query is modified by an existing processing unit compared to an originally defined data query, so that alternative data is provided and, in a specific response, reproduced via the output section or transmitted to an external reproduction device. Consequently, when using one and the same ID card which was originally configured to output, in a specific response, a first processed audio and/or image information item, such as a first video file from a media library, after reprogramming a user receives a second processed audio and/or image information item, for example a second video file from a media library, instead of the original, first audio and/or image information item.

Furthermore, in the described system, the programming of the triggered specific response can be changed, in particular without a physical connection to the apparatus, for example via the Internet. Consequently, via an app available from common app stores, the user or a person trusted by the user is able to change the processed audio and/or image information provided in the specific response of the apparatus according to the invention, within a predefined range related to the choices of digital content provided, so as to generate an alternative data output.

In a preferred embodiment of the described system, the in particular fewer than four controls and preferably two controls can be configured for browsing elements of digital correspondence or digital media, for example e-mails, photos, videos or musical works. This enables control of the most important operations. In this context, the term browsing refers to simple control commands for the audio and/or image information processed and output by the apparatus according to the invention, for example “left/right” or “backwards/forwards”. This makes handling of the apparatus according to the invention as easy as possible.

Optionally, the described system may be characterized in that the removal of an ID card from the rectangular recess terminates the reproduction or transmission of the audio or image information, in particular within one second. This allows the user to operate the apparatus according to the invention solely by using an ID card, without performing any further operator actions. As long as no ID card is placed in the rectangular recess, the apparatus is in sleep mode with the power supply connected.

The present invention is described in greater detail below on the basis of an exemplary embodiment with reference to the accompanying drawings. These show the following:

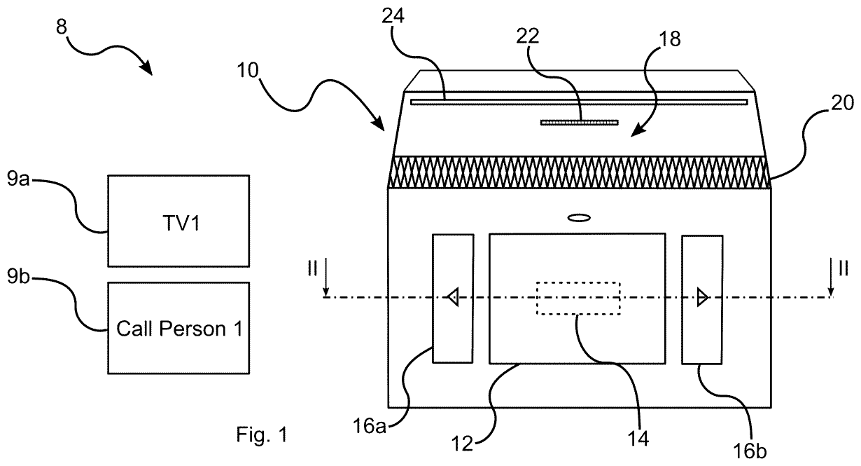

FIG. 1A top view of a system comprising an apparatus according to the invention for processing audio and/or image information and two ID cards.

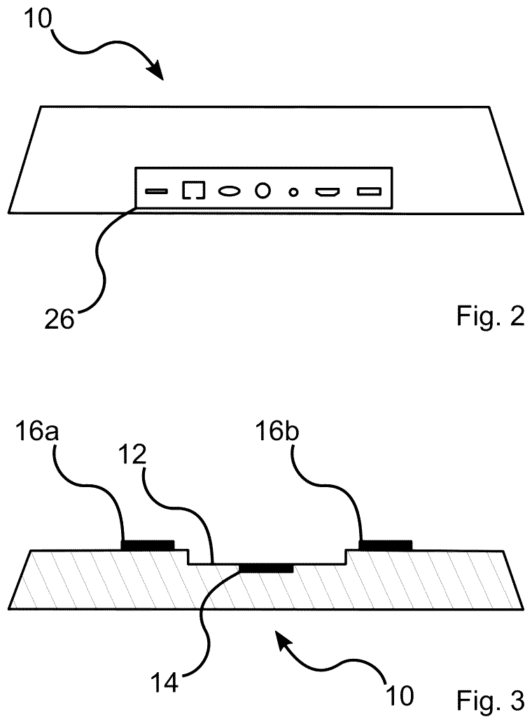

FIG. 2A rear view of a section of an apparatus according to the invention.

FIG. 3A side cross-sectional view of an apparatus from FIG. 1, running along line II-II of FIG. 1.

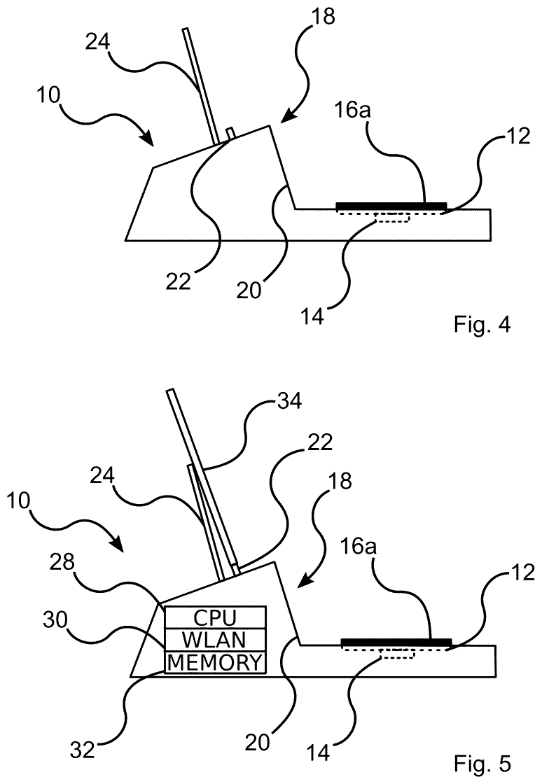

FIG. 4A side view of an apparatus according to the invention.

FIG. 5A side view of an apparatus according to the invention which has a tablet docked onto it.

FIG. 1 illustrates a system 8 comprising, for example, two ID cards 9a,b with a stored RFID identifier, preferably an NFC identifier, and an apparatus according to the invention for processing audio and/or image information, the apparatus generally being indicated by the reference sign 10. The ID cards 9a,b can be labeled and/or color coded according to their identifier and consequently their triggered specific action. The ID cards 9a,b are preferably designed in the common credit card format according to ISO/IEC standard 7810. The apparatus 10, which is a tabletop device with its own power supply, includes a rectangular recess 12 disposed centrally on the front portion of the apparatus 10 and forming, for example, a horizontal placement area. The size of the recess 12 can be based on the credit card format according to ISO/IEC standard 7810 and preferably have a depth of 0.9 to 0.6 mm. On the bottom of the rectangular recess 12 there is a sensor 14 which has a receiver and/or transmitter for an RFID identifier, preferably an NFC identifier, said sensor 14 being shown only schematically in the top view.

In the embodiment shown here, the apparatus 10 comprises two controls 16a,b, these preferably being disposed to the left and right of the rectangular recess 12. The rear section of the apparatus 10 includes an output section 18, which includes an integral loudspeaker 20 and a docking apparatus 22 for a multimedia device, such as a tablet. Moreover, a mounting support 24 for the multimedia device may be disposed on the rear portion of the apparatus 10.

A plug-in connection module 26, which may include a plurality of plug-in connectors, such as a connector for a power supply, an external loudspeaker, an external multimedia device, an Ethernet, USB or HDMI port or a SIM card module, is provided in a rear panel of the apparatus 10, as shown for example in FIG. 2. In this case, the plug-in connectors may be connected to corresponding electronic components inside the apparatus.

FIG. 3 shows a side cross-sectional view of an apparatus of FIG. 1, running along line II-II of FIG. 1, revealing an exemplary arrangement of the rectangular recess 12, the sensor 14, and the controls 16a,b. The sensor 14 can thus be centrally located on the bottom of the rectangular depression 12.

The apparatus 10 according to the invention is shown in a side view in FIG. 4, this view showing the exemplary configuration of the output section 18 including loudspeaker 20 and docking apparatus 22 for a multimedia device. Moreover, the mounting support 24 may be positioned in the immediate vicinity of the docking apparatus 22 so as to support a multimedia device, thereby reducing pressure on the docking apparatus 22.

Following on from FIG. 4, FIG. 5 illustrates a side view of the apparatus 10 according to the invention such that the presence of electronic components, for example a processing unit 28, a WLAN wireless network adapter 30 and/or an internal memory 32 can be seen, these electronic components being interconnected and the processing unit 28 being adapted to process identifier-specific signals provided by the sensor. It also shows the exemplary use of a tablet 34 docked onto the apparatus 10 via the docking apparatus 22.

There follows a selection of possible specific actions which may be triggered by the placement of an ID card 9a or 9b with a stored RFID identifier, preferably an NFC identifier, in the rectangular recess 12 and provided in the form of audio and/or image information by the output section 18:

1
Phone call to a specific person or institution
Video call to a specific person or institution
Accessing a specific TV channel
Accessing a specific radio channel
Requesting the weather forecast
Playing a specific video from a media library
Playing a specific musical work or spoken work from a media library
Accessing specific images, which are stored in a digital library
Accessing specific written works, which are stored in a digital library
Accessing digital correspondence, for example e-mails or messaging services
Accessing a specific web site
Accessing a specific file stored in the internal memory of the apparatus 10 or a connected external memory
Accessing a specific application stored in the internal memory of the apparatus 10.
Accessing a digital calendar

The following is a description of an exemplary implementation of the system 8 comprising two ID cards 9a,b with stored RFID identifier and the apparatus 10 according to the invention:

From a collection of color-coded and labeled ID cards 9a,b with stored RFID identifiers, a user selects the specific ID card “Video Call Person 1” and places it in the rectangular recess 12 of the apparatus 10 according to the invention, which is continuously supplied with power and is in sleep mode until the ID card is put in place. At the same time, a tablet 34 is connected to the apparatus 10 via a docking apparatus 22 and is thus supplied with power. The tablet 34 is in sleep mode. The sensor 14, which comprises a receiver and/or transmitter for an RFID identifier and is mounted on the bottom of the rectangular recess 12, registers the specific identifier of the ID card “Video Call Person 1” and, in a specific action, sends a signal to the processing unit 28 and/or an app installed on the tablet 34, which will recognize the identifier-specific signal and consequently initiate a specific data request. The apparatus 10 according to the invention is thus adapted to wake the docked tablet 34 from sleep mode. The data request is made by communicating with a server on which a wide range of identifier-specific actions are stored, and is established, for example, via a WLAN wireless network provided by the apparatus 10 or the tablet 34. The data resulting from the data request is then transmitted to the output section 18 in a specific response, thereby making it available for output via the tablet 34. Consequently, in the case of the specific identifier “Video Call Person 1”, a video call with Person 1 is started immediately, where “Person 1” is, for example, a previously defined person trusted by the user. If Person 1 accepts the video call, the user can, for example, control the volume of the audio output by means of the two controls 16a,b. When the user wishes to end the video call, this is done by removing the ID card from the rectangular recess 12, whereupon both the apparatus 10 and the tablet 34 enter sleep mode.

1. Apparatus for processing audio and/or image information, comprising:
a substantially rectangular recess adapted for placement of an ID card;
a sensor for detecting an identifier stored on the ID card;
two controls for controlling the processing of the audio or image information; and
an output section which is adapted to reproduce the audio or image information or to transmit the audio or image information to an external reproduction device.

2. Apparatus according to claim 1, wherein the rectangular recess forms a placement area, a size of the recess being adapted to allow substantially horizontal placement of an ID card.

3. Apparatus according to claim 1, wherein the sensor comprises a receiver and/or transmitter for an RFID identifier.

4. Apparatus according to claim 1, where the apparatus is adapted to trigger a specific action upon the placement of an ID card, which action is output in the form of a specific response of the output section or the external reproduction device.

5. Apparatus according to claim 4, which is adapted to output the triggered specific response without further operator action by a user.

6. Apparatus according to claim 4, wherein the triggered specific response of the output section or of the external reproduction device includes the output or display of digital correspondence or digital media stored in libraries, or the output or display of phone calls or video calls.

7. Apparatus according to claim 4, wherein a triggered specific response in the form of an audio or video communication is established without any further user action.

8. Apparatus according to claim 1, wherein only one RFID identifier is present per ID card at any one time.

9. Apparatus according to claim 1, wherein the two controls are disposed adjacent to the rectangular recess.

10. Apparatus according to claim 1, wherein the output section includes a docking station for a multimedia device.

11. System comprising one apparatus and at least two ID cards according to claim 1, wherein a first ID card of the at least two ID cards has an RFID identifier which triggers a first specific response, and a second ID card of the at least two ID cards has a second RFID identifier which triggers a second specific response.

12. System according to claim 11, wherein the specific response of the output section or of the external reproduction device is triggered exclusively by the identifier of an ID card of the at least two ID cards.

13. System according to claim 12, wherein the triggered specific response can be reprogrammed any number of times.

14. System according to claim 13, wherein programming of the triggered specific response can be changed without any physical connection to the apparatus, for example via the Internet.

15. System according to claim 14, wherein the two controls are configured for browsing elements of digital correspondence or digital media, such as emails, photos, videos, or musical works.

16. System according to claim 15, wherein removal of an ID card of the at least two ID cards from the rectangular recess terminates the reproduction or transmission of the audio or image information within one second.

17. Apparatus according to claim 3, wherein the RFID identifier is an NFC identifier.

18. System according to claim 11, wherein the first and second RFID identifiers are NFC identifiers.
